(19) United States
(12) Patent Application Publication
(10) Pub. No.: US 2006/0128311 A1
(43) Pub. Date: Jun. 15, 2006

(54) Matching receive signal strenth data associated with radio emission sources for positioning applications

(76) Inventor: Yohannes Tesfai, Silver Spring, MD (US)

Correspondence Address: EDELL, SHAPIRO & FINNAN, LLC, 1901 RESEARCH BOULEVARD, SUITE 400, ROCKVILLE, MD, 20850, US

(21) Appl. No.: 11/010,867

(22) Filed: Dec. 13, 2004

(51) Int. Cl. H04B 17/00

(52) U.S. Cl. 455/67.11; 455/456.5

(57) ABSTRACT

A system, method and software for determining a position of a source of a radio emission. Receive signal strength data associated with reception of radio emissions is generated at each of a plurality of radio sensor devices that are at corresponding known positions in an area where the radio emissions are occurring. Using characteristics associated with reception of the radio emissions at each of the sensor devices, the receive signal strength data generated by each of the sensors is matched as corresponding to a radio emission from the same source. The characteristics used to match receive signal strength data may include spectrum analysis data and/or timing analysis data. Once the receive signal strength data is matched, position computations may be performed on the appropriate set of receive signal strength data to compute the position of the source of the radio emission.

### RELATED APPLICATIONS

This application is related to the following commonly assigned and co-pending applications:

U.S. application Ser. No. 10/717,852, filed Nov. 19, 2003, entitled “Server and Multiple Sensor System for Monitoring Activity in a Shared Radio Frequency Band”.

U.S. application Ser. No. 10/909,455, filed Aug. 2, 2004, entitled “Automated Real-Time Site Survey in a Shared Frequency Band Environment”.

### BACKGROUND OF THE INVENTION

The explosive growth in wireless applications and devices over the past few years has produced tremendous public interest benefits. Wireless networks and devices have been deployed in millions of offices, homes, and more recently, in increasing numbers of public areas. These wireless deployments are forecast to continue at an exciting pace and offer the promise of increased convenience and productivity.

This growth, which is taking place mostly in the unlicensed bands, is not without its downsides. In the United States, the unlicensed bands established by the FCC consist of large portions of spectrum at 2.4 GHz and at 5 GHz, which are free to use. The FCC currently sets requirements for the unlicensed bands such as limits on transmit power spectral density and limits on antenna gain. It is well recognized that as unlicensed band devices become more popular and their density in a given area increases, a “tragedy of the commons” effect will often become apparent and overall wireless utility (and user satisfaction) will collapse. This phenomenon has already been observed in environments that have a high density of wireless devices.

Enterprise uses of the unlicensed band are focused on larger scale deployment of wireless networks (e.g., WLANs) and integration into wired networks. WLANs can complicate existing network management schemes because they introduce the additional requirement of efficiently managing radio spectrum. Current WLAN systems and management technology are focused on managing activity at the network level of the WLAN, but provide little or no capability to manage the frequency band where signals of multiple types (e.g., communication protocol/network types, device types, etc.) are present.

The types of signaling protocols used by devices in the unlicensed bands are not designed to cooperate with signals of other types also operating in the bands. For example, a frequency hopping signal (e.g., a signal emitted from a device that uses the Bluetooth™ communication protocol or a signal emitted from certain cordless phones) may hop into the frequency channel of an IEEE 802.11 wireless local area network (WLAN), causing interference with operation of the WLAN. Thus, technology is needed to exploit all of the benefits of the unlicensed band without degrading the level of service that users expect.

Techniques are needed to determine the position of sources of numerous types of radio emissions, such as those that may interfere with radio communication occurring in accordance with a particular radio communication protocol or standard, such as an IEEE 802.11 WLAN communication standard.

### SUMMARY OF THE INVENTION

Briefly, a system, method and software are provided for determining a position of a source of a radio emission. Receive signal strength data associated with reception of radio emissions is generated at each of a plurality of radio sensor devices that are at corresponding known positions in an area where the radio emissions are occurring. Using characteristics associated with reception of the radio emissions at each of the sensor devices, the receive signal strength data generated by each of the sensors is matched as corresponding to a radio emission from the same source. The characteristics used to match receive signal strength data may include spectrum analysis data and/or timing analysis data. Once the receive signal strength data is matched, position computations may be performed on the appropriate set of receive signal strength data to compute the position of the source of the radio emission.

These techniques are useful to determine the position of a source of a radio emission of numerous types. For example, certain radio emissions may interfere with operation of radio communication that is occurring in accordance with a particular radio communication standard, such as an 802.11 WLAN, and therefore it is desirable to determine the position of those emission sources in order to disable or relocate them.

The above and other advantages of this technique will become more apparent when reference is made to the following description taken in conjunction with the accompanying drawings.

### BRIEF DESCRIPTION OF THE DRAWINGS

FIG. 1 is a block diagram of a system in which the positions of sources of radio emissions can be determined using a plurality of sensor devices and a server computing device.

FIG. 2 is a time-frequency contour plot showing various types of radio emissions that may be detected by a radio sensor device and whose location is to be determined.

FIG. 3 is a block diagram of a sensor device.

FIG. 4 is a block diagram of the major functions in the radio sensor devices and server computing device.

FIG. 5 is a flow chart depicting a process for matching receive signal strength data produced at each radio sensor device to the same radio emission for purposes of determining the position of the source of the radio emission.

FIG. 6 is a timing diagram for an exemplary radio emission that is received by each of the sensor devices.

FIG. 7 is a timing diagram showing a technique for time synchronizing the sensors.

FIG. 8 is a flow chart for the time synchronization technique shown in FIG. 6.

FIG. 9 is a diagram depicting flow of data for another process to match receive signal strength data produced at each radio sensor device to the same radio emission.

FIG. 10 is a flow chart depicting the steps of the process represented by FIG. 8.

FIG. 11 is a diagram similar FIG. 6 and showing another technique for matching receive signal strength data of radio emissions.

### DETAILED DESCRIPTION

The system, methods, software and other technologies described herein are designed to cooperatively manage use of a shared frequency band where signals of multiple types occur (often simultaneously), such as an unlicensed band, and interference among the users of the band may occur. Many of the concepts described herein may apply to frequency bands that are not necessarily “unlicensed,” such as when a licensed frequency band is used for secondary licensed or unlicensed purposes.

The term “network” is used hereinafter in many ways. There may be one or more wireless networks each comprising multiple devices or nodes that operate in the shared frequency band. One example of such a network is a WLAN. There are also networks, called piconets, which are formed with Bluetooth™ (master and slave) devices. Many of the examples described herein are made with respect to an IEEE 802.11 (also known as WiFi™) WLAN, mostly due in part to the expansive use that the WLAN has seen, and is expected to continue to see. In addition, the term network is referred to a wired network, and to an aggregation of one or more wired and wireless networks. The systems, methods, software and device features described herein are not limited to any particular wireless network, and are equally applicable to any wireless network technologies now known or hereinafter developed.

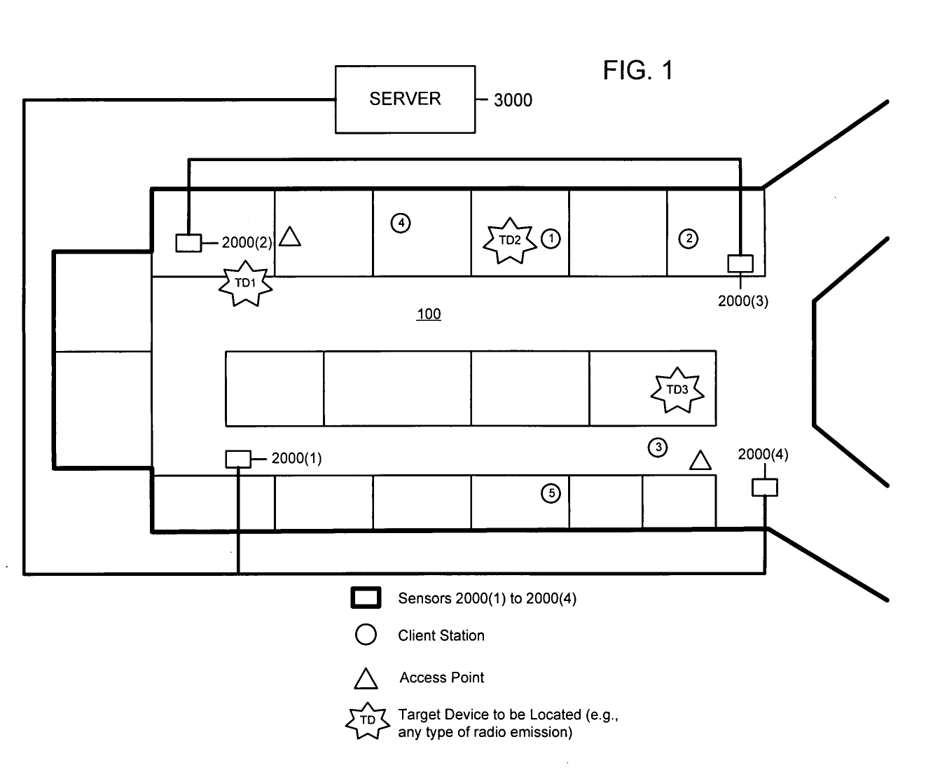

Referring first to FIG. 1, a high level diagram of the server-sensor system is shown. The sensors 2000(1) to 2000(N) connect to a server 3000 via a local area network, e.g., Ethernet, or possibly a wireless link. The sensors 2000(1) to 2000(N) (four are shown as an example only) are positioned at various positions in an area 100, such as an office environment or other type of area or region, such as a manufacturing floor, trading floor, etc. The sensors 2000(1) to 2000(N) receive radio emissions in the area 100 in order to generate and supply data useful in knowing what types of signals are occurring in the area and the positions of the sources of those signals. The server 3000 may run on a dedicated server computer, or it may be integrated with other servers such as WLAN switches, authentication servers or management servers. The server 3000 manages all of the sensors it communicates with. It aggregates data from the sensors, performs analysis on the data and presents the data in formats amenable to other network management entities.

The area 100 is represented by a map or layout and the sensors 2000(1) to 2000(4) are deployed at appropriate positions in the area 100. Also shown are access points (APs) and a plurality of client stations (STAs) or mobile devices that operate in compliance with a particular communication protocol such as an 802.11 WLAN protocol. Devices that do not operate according to this communication protocol are shown as target devices (TDs) 1-3, and these devices may interfere with the operation of the other the 802.11 WLAN because they emit energy in the same frequency band of operation. It is desirable to determine the positions of the TDs. The sensors 2000(1) to 2000(4) receive and analyze the emissions made by the TDs 1-3 in order to characterize them (and possibly classify or identify them) and forward data to the server that the server uses to estimate their position. The TDs 1-3 may be of the same or different type. For example, TD 1 may be a microwave oven, TD2 may be a Bluetooth™ headset (slave and master) and TD3 may be a cordless phone.

When a position computation estimate is performed for a radio emission source, the server 3000 uses a set of RSS data consisting of RSS data associated with reception of the radio emission(s) from that source at each of the sensors. This set of RSS data may be referred to as a relevant set of RSS data because it relates to reception at each of the sensors of a radio emission from the same source. In some situations, the sensors 2000(1) to 2000(4) may not have the capability to demodulate radio emissions of an TD (assuming the TD is a device operating in accordance with some type of communication protocol). For example, the sensors may have capability to demodulate 802.11 WLAN radio emissions but not Bluetooth™ radio emissions. Consequently, the sensors cannot recover an address such as a MAC address or other source identifier embedded in the TD emission, or otherwise capture sufficient characteristics about the radio emission from demodulating it, in order to match RSS data generated at each of the sensors as corresponding to a radio emission from the same source to form a relevant set of RSS data necessary for position estimation. Other techniques described below are used to match the RSS data generated at each of the plurality of sensors as corresponding to a radio emission from the same source.

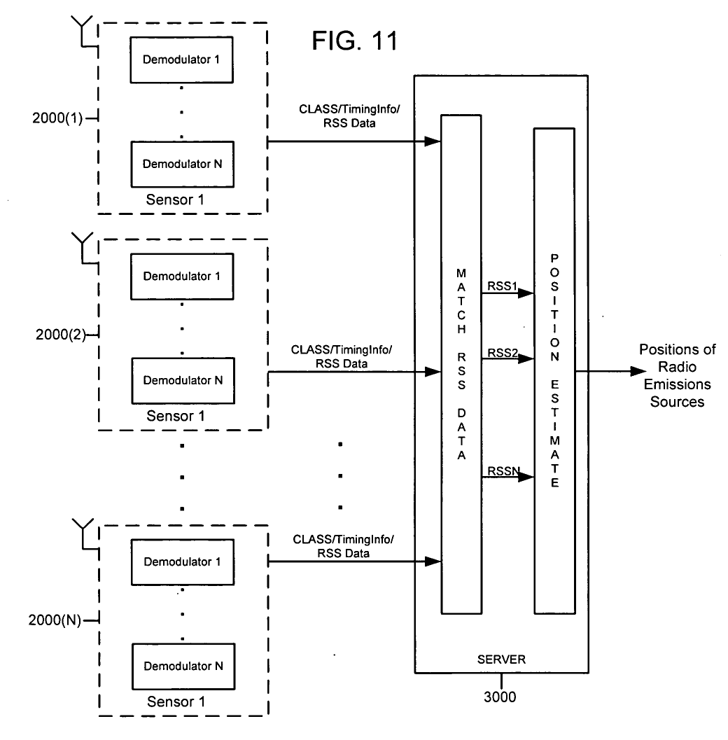

On the other hand, if the sensors have the capability of demodulating the radio emissions of the TDs as described hereinafter in connection with FIG. 11, then the sensors can forward the receive signal strength and signal type (or source identifier) information associated with the signals they recognize by virtue of demodulating the radio emissions as they receive them.

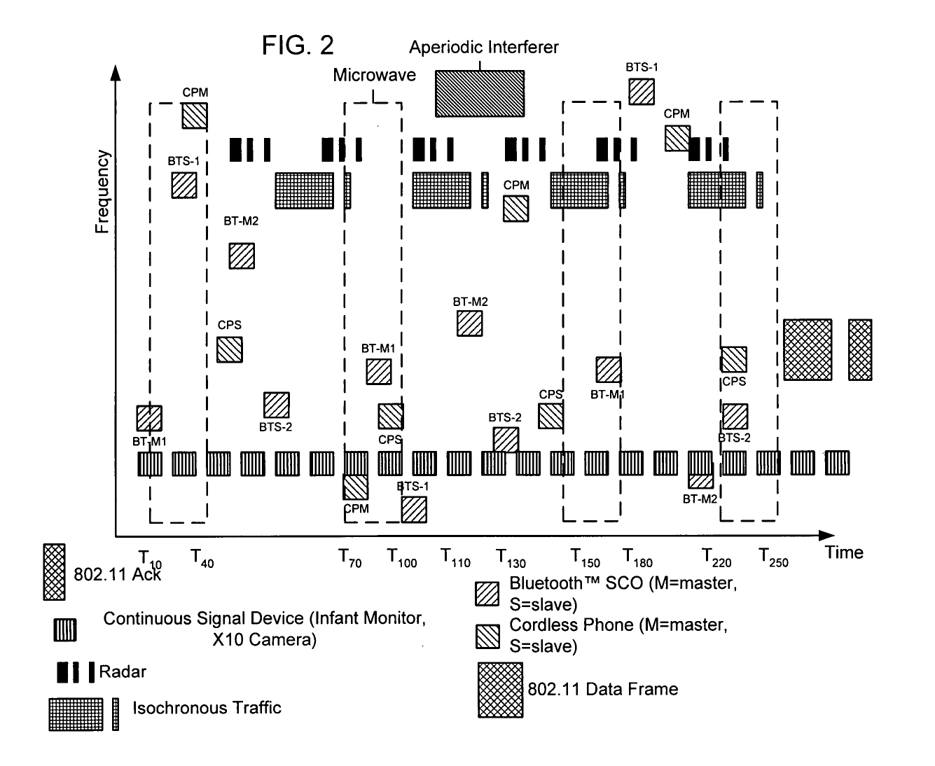

FIG. 2 illustrates a time-frequency contour plot of a variety of 802.11 WLAN and other radio (e.g., non-802.11) emissions that may be occurring in the same frequency band. The TDs shown in FIG. 1 may be any one or more of the radio emission types shown in FIG. 2, or others. For example, one TD may be a Bluetooth™ device associated with one piconet and another TD may be a different Bluetooth™ device associated with a different piconet. In any case, FIG. 2 shows that there are numerous types of radio emission that may be occurring at the same time. To determine the position of any one or more of the sources of these radio emissions, it is necessary to identify a relevant set of RSS data produced by the sensors. The concept of the relevant set of RSS data is described hereinafter.

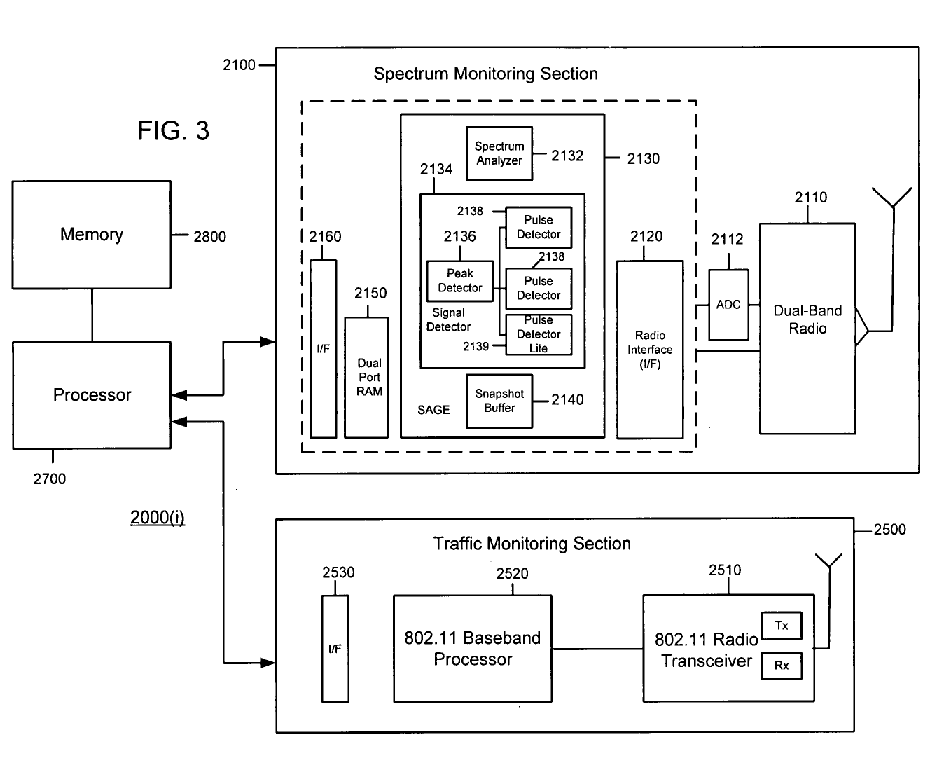

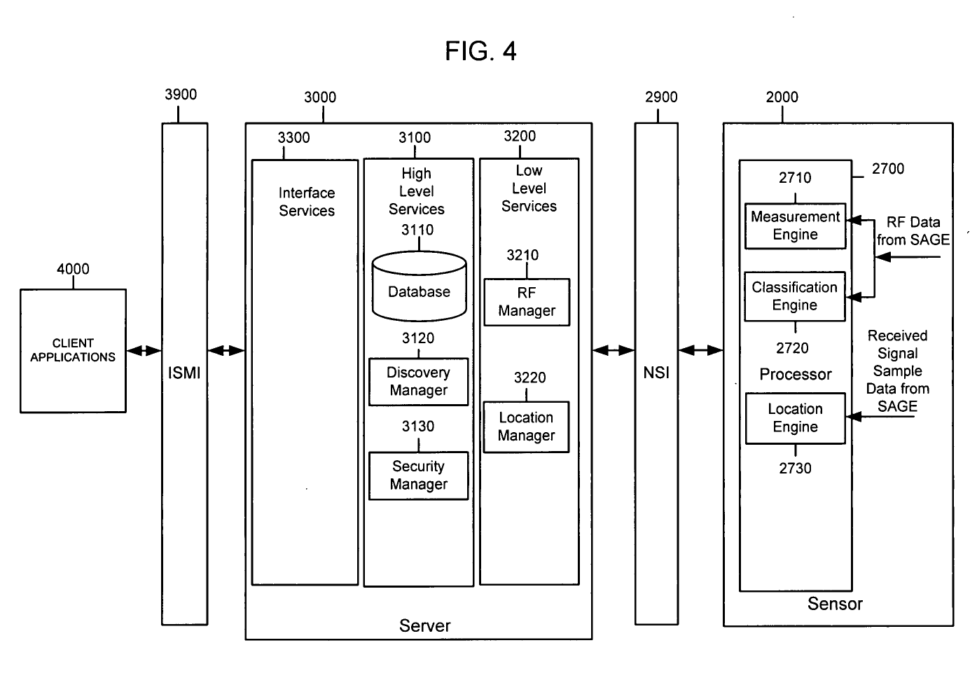

FIGS. 3 and 4 illustrate the functionality of the sensors when the sensors do not have the demodulation capability for each of the numerous types of TDs to be expected. Rather than identify each TD emission through demodulation, the receive signal strength data from the sensors is matched using spectrum analysis and timing analysis of the receive radio emissions.

The Sensor

Turning now to FIG. 3, each sensor 2000(i) comprises a spectrum monitoring 2100 section to monitor RF activity in the frequency band and a traffic monitoring section 2500 that is capable of sending and receiving traffic according to a communication protocol, such as an IEEE 802.11 WLAN protocol. The spectrum monitoring section 2100 comprises a radio 2110 (primarily for receive operations) that is capable of tuning to receive energy at each channel (or simultaneously all channels in a wideband mode) of, for example, any of the unlicensed bands (2.4 GHz and 5 GHz) in which IEEE 802.11 WLANs operate. An analog-to-digital converter (ADC) 2112 is coupled to the radio 2100 that converts the downconverted signals from the radio 2100 to digital signals. A radio interface (I/F) 2120 is coupled directly to the radio 2100 and also to the output of the ADC 2112. A real-time spectrum analysis engine (SAGE) 2130 is coupled to the radio I/F 2120. The SAGE 2130 includes a spectrum analyzer 2132, a signal detector 2134 consisting of a peak detector 2136 and one or more pulse detectors 2138 and 2139, and a snapshot buffer 2140. A Fast Fourier Transform (FFT) block (not shown) is coupled between the I/F 2120 and the spectrum analyzer 2132, or included in the spectrum analyzer 2132. The SAGE 2130 generates spectrum activity information that is used in the sensor and the server to determine the types of signals occurring in the frequency band, and produces receive signal strength information of received radio emissions for position measurement operations. A dual port random access memory (RAM) 2150 is coupled to receive the output of the SAGE 2130 and a processor I/F 2160 interfaces data output by the SAGE 2130 to a processor 2700, and couples configuration information from the processor 2700 to the SAGE 2130.

The functions of the SAGE 2130 will be briefly described in further detail hereinafter, but more details on the SAGE can be found in commonly assigned U.S. Pat. No. 6,714,605, commonly assigned co-pending U.S. application Ser. No. 10/420,511, filed Apr. 22, 2003, entitled “System and Method for Real-Time Spectrum Analysis in a Radio Device,” and commonly assigned co-pending U.S. patent application Ser. No. 10/904,450, filed Aug. 2, 2004, entitled “Pulse Detection Scheme for Use in Real-Time Spectrum Analysis.” The spectrum analyzer 2132 generates data representing a real-time spectrogram of a bandwidth of radio frequency (RF) spectrum, such as, for example, up to 100 MHz. The spectrum analyzer 2132 may be used to monitor all activity in a frequency band, for example, the 2.4-2.483 GHz ISM band, or the 5.15-5.35 GHz and 5.725-5.825 GHz UNII bands. The FFT block referred to above is, for example, a 256 frequency bin FFT block that provides (I and Q) FFT data for each of 256 frequency bins that span the bandwidth of frequency band of interest. An FFT block with greater resolution or bandwidth may be used as well. The spectrum analyzer 2132 may further comprise a power computation block that computes (FFTdataI)2 and (FFTdataQ)2, respectively, and adds them together, to output a power value for each FFT frequency bin. The spectrum analyzer 2132 may further include a stats logic block that has logic to accumulate statistics for average power, duty cycle, maximum power and a peaks histogram. Statistics are accumulated in the dual-port RAM over successive FFT time intervals. After a certain number of FFT intervals, determined by a configurable value stored in the spectrum analyzer control registers, an interrupt is generated to output the stats from the dual-port RAM. For example, the stats are maintained in the dual-port RAM 2150 for 10,000 FFT intervals before the processor reads out the values. The power versus frequency data generated by the spectrum analyzer 2132 is also used as input to the signal detector.

The signal detector 2134 detects signal pulses in the frequency band and outputs pulse event information entries, which include one or more of the start time, duration, power, center frequency and bandwidth of each pulse that satisfies configurable pulse characteristic criteria associated with a corresponding pulse detector.

In the signal detector 2134, the peak detector 2136 looks for spectral peaks in the (power versus frequency data derived from FFT block output), and reports the bandwidth, center frequency and power for each detected peak. The output of the peak detector 2136 is one or more peaks and related information. The pulse detectors 2138 detect and characterize signal pulses based on input from the peak detector 2136. A pulse detector lite 2139 may be employed to generate pulse events in a manner slightly different from pulse detectors 2138, as described in the aforementioned co-pending application entitled “Pulse Detection Scheme for Use in Real-Time Spectrum Analysis” filed on Aug. 2, 2004.

The snapshot buffer 2140 collects a set of raw digital signal samples useful for signal classification and other purposes, such as position measurements. The snapshot buffer 2140 can be triggered to begin sample collection from either the signal detector 2134 or from an external trigger source, such as a signal from the processor to capture received signal data for a period of time sufficient to include a series of signal exchanges used for location processing explained hereinafter. Alternatively, the snapshot buffer is in a free-running state continuously storing captured and then in response to detecting a particular signal, the snapshot buffer is put into a post-store mode that extends long enough to capture additional signal data expected to be sent in response to the particular signal. Furthermore, the captured raw data may be used for generated receive signal strength data of a received radio emission. The sensor can generate a receive signal strength measurement computation from the raw digital samples captured by the snapshot buffer using knowledge of the gain setting of the radio receiver 2110 (FIG. 3) and knowledge of the conversion levels of the ADC 2112.

The traffic monitoring section 2500 monitors packet activity in a wireless network, e.g., a WLAN, and sends and receives certain packets that are used for location measurement processes. The traffic monitoring section 2500 may also be used to transmit a beacon frame or other signal that contains time stamp information related to the clock of a particular radio sensor device for sensor synchronization purposes described hereinafter. Included in the traffic monitoring section 2500 are a radio transceiver 2510 (comprising a transmitter Tx and a receiver Rx) and a baseband signal processor 2520. The radio transceiver 2510 and baseband signal processor 2520 may be part of a package chipset available on the market today, such as an 802.11 WLAN chipset for any one or more of the 802.11 a/b/g or other WLAN communication standards. The baseband signal processor 2520 is capable of performing the baseband modulation, demodulation and other PHY layer functions compliant with the one or more communication standards of interest (e.g., IEEE 802.11a,b,g,h, etc.). An I/F 2530 couples the baseband signal processor 2520 and radio transceiver 2510 to the processor 2700.

There may be other traffic monitoring sections in the sensor to monitor communication protocol type activity of other types, such as Bluetooth™ communications.

The processor 2700 performs the various processing algorithms described herein on the output of the SAGE 2130 and on received packets from the traffic monitoring section 2500. The processor I/F 2160 of the spectrum monitoring section 2100 and the processor I/F 2530 of traffic monitoring section 2500 may be a Mini-PCI or PC-Card (e.g., Cardbus™) interface, or any other interface known in the art. While not shown in FIG. 2, there is also an LAN interface block (e.g., Ethernet) that is coupled to the processor 2700 to enable the sensor to communicate with the server with a wired LAN connection. The processor 2700 may generate signals to control the radio 2110 independently of the radio transceiver 2510, such that spectrum monitoring is occurring on one channel while protocol monitoring is simultaneously occurring on another channel, for example.

It is envisioned that a WLAN AP may include all of the functionality of a sensor described above, and may be switched between AP operating mode and a sensor operating mode.

Turning to FIG. 4, a high level diagram is shown of the major functional blocks in the sensor 2000 and server 3000, as well as the interfaces between the sensor 2000 and server 3000, and between client applications 4000 and the server 3000. In the sensor 2000, there are functions performed by the processor (executing one or more software programs) including a measurement engine 2710, a classification engine 2720 and a location engine 2730. The measurement engine 2710 and classification engine 2720 operate on RF data from the SAGE 2130. The location engine 2730 operates on raw received signal data obtained by the SAGE 2130.

The interface between the sensor 2000 and the server 3000 is referred to as a network spectrum interface (NSI) 2900.

The server 3000 may run on a dedicated server box, or it may be integrated with other servers such as WLAN switches, authentication servers or management servers. There are high level services 3100, low level services 3200 and interface services 3300. The high level services 3100 include a database 3110, discovery manager 3120, performance manager 3130 and security manager 3140. The low level services 3200 manages interfaces with client applications 4000 by an application programming interface (API) called the intelligent spectrum management interface (ISMI) 3900.

The Sensor Functions

The software functions of the sensor 2000 will be first described in more detail.

The measurement engine 2710 software in the sensor is responsible for communicating with the SAGE driver software to configure the SAGE 2130 in the sensor 2000. In addition, the measurement engine 2710 manages the resources of the SAGE 2130 between spectrum monitoring functions and device location functions. The measurement engine 2710 also collects and aggregates data from the SAGE 2130 into meaningful units. The functions of the measurement engine 2710 and classification engine 2720 may be incorporated into a single functional block, event though they are shown as two blocks. Furthermore, the measurement engine 2710 may configure reporting of data and statistics generated by the SAGE 2130 and adjust the frequency channel (and/or scan rate) on which the SAGE 2130 operates. The measurement engine 2710 may also operate the radio receiver in the sensor in a wideband mode to simultaneously process data across an entire unlicensed frequency band of interest. The measurement engine 2710 produces the spectrum activity data from raw spectrum analysis and snapshot buffer data output by the SAGE 2130. The spectrum activity data, simply put, comprises data representing one or more of time, frequency and power of radio frequency energy received in a portion (or all) of a frequency band.

One function of the measurement engine 2710 is to control which bands are monitored, and to produce streams from spectrum analyzer statistics (SA STAT) and pulses produced by the SAGE. A SA STAT stream consists of one or more of: maximum power, average power, and average duty cycle for each of a plurality of FFT bins, or a frequency range. One or more of these statistics for a time interval of a receive radio emission may be used to match receive emissions at the sensors.

A pulse stream reports on individual pulses that have been detected by the sensor.

A pulse histogram stream provides histogram data on attributes of pulses detected by the sensor, including histograms for center frequency, bandwidth, duration, inter-pulse (gap, e.g., start to start), and power.

The classification engine 2720 classifies/identifies signals occurring in the frequency based on the output of the SAGE 2130. Examples of signals that the classification engine 2720 may identify include Bluetooth™ signals, microwave oven signals, cordless telephones, wireless headsets, radar, wireless video cameras, etc. Techniques for signal classification are described in greater detail in commonly assigned and co-pending U.S. patent application Ser. No. 10/246,364, filed Sep. 18, 2002, entitled “System and Method for Signal Classification of Signals in a Frequency Band”; U.S. patent application Ser. No. 10/420,362, filed Apr. 22, 2003, entitled “System and Method for Classifying Signals Occurring in a Frequency Band”; and U.S. patent application Ser. No. 10/628,603, filed Jul. 28, 2003, entitled “System and Method for Classifying Signals Using Timing Templates, Power Templates and Other Techniques”; and U.S. patent application Ser. No. 10/830,414, filed Apr. 22, 2004, entitled “Signal Classification Methods for Scanning Receiver and Other Applications.” The entirety of each of these applications is incorporated herein by reference. The classification engine 2720 may generate events (at a configurable update rate) associated with classified signals.

There are several types of classification events or reports including:

Up: A device has been detected, and has met some minimal confidence level. The measurements include all pulses received until the record is generated.

Down: A device is no longer detectable. This may result because the device has stopped transmitting, that its transmissions are below the sensor's detection sensitivity that the template has been unloaded, or that monitoring of the band has been cancelled. The measurements include all pulses since the last event record for this instance, and under some cases there may have been no pulses since the last record.

Periodic Update: Since an instance may persist for an extended period of time and the measurements may vary over that interval, the classification engine can be directed to produce periodic measurement records. The measurements include all pulses since the last event record for this instance.

The following fields may be present in a classification event record.

Timestamp: This provides a reference timestamp for the event.

Instance ID: This is a unique ID assigned to each new instance as it is classified. It can be used to match Update and Down events with the matching Up event.

Template ID: This identifies the classification template used to classify the device. This implies the name, version, and framework ID to the server.

Event Type: This is one of the event types, listed above.

Confidence Level: This is a number from 0 to 100, used to indicate confidence of the classification.

Average Power: This is the average energy measured across all pulses measured in this record.

Receive Signal Strength Data. Data produced from raw captured digital samples by the snapshot buffer of the SAGE block in a sensor.

The location engine 2730 in the sensor may generate receive signal strength data associated with a received radio emission that is used to compute the location of devices operating in a space in which the sensors are positioned. The location engine 2730 makes receive signal strength measurements based on raw digital sample data captured by the snapshot buffer in the sensor for a received radio emission.

Alternatively, the SAGE block in each sensor may produce receive signal strength data in the course of the spectrum analysis it performs on detected energy, and the classification engine in the sensor supplies receive signal strength data as an element in the classification report. For example, the received signal strength may be derived from the average power of pulses associated with a radio emission captured by the SAGE block.

The capabilities of the sensor 2000 shown in FIG. 2 may be incorporated into a client station, such as an 802.11 WLAN client station that is a mobile device, or into an 802.11 WLAN AP. In this case, the traffic monitoring section 2500 would handle all 802.11 communications, and the spectrum monitoring section 2100 would handle the real-time spectrum analysis, together with the processor 2700 which would handle the software functions described above for measurement, classification, location, etc. Alternatively, the spectrum monitoring section 2100 and traffic section 2500 may share the same 802.11 radio.

The Server Functions

Again, with reference to FIG. 4, the high level services 3100 of the server 3000 will now be described. The server, as is known in the art, consists of a computer processor and associated memory (computer readable medium) that executes software programs (stored in the memory) to perform a variety of functions described herein.

The database 3110 provides physical storage of spectrum information, events and related information generated by the sensors. In addition, the database 3110 maintains configuration information pertaining to the functions in the server 3000 and many functions in the sensors.

Discovery

The discovery manager 3120 in the server processes data pertaining to the discovery of new devices operating in the frequency band, such as 802.11 and other devices, and the physical location of those devices. Discovery involves handling reports from sensors concerning the up (and new) and down state of such devices. Also, multiple sensors may see the same 802.11 device coming up. A discovery event associated with an 802.11 device may fall into one of the following classes: ours, known others, new and rogue. To this end, the discovery manager 3120 may maintain a list of authorized APs and STAs so that when a new device is detected by a sensor, the discovery manager 3120 can determine whether or not it is authorized. Alternatively, the security manager, described hereinafter, could be the software process that maintains the list of authorized devices and determines the status of newly discovered devices.

Similarly, the discovery manager 3120 also processes data pertaining to known and unknown interferers and handles associated events including up, down, new, and duplicate suppression. The sensors report on new known (classifiable) and unknown (unclassifiable) interferer devices.

The discovery manager 3120 executes a scan policy. When a new device is discovered and is in the management domain of the server, a request is made to the location manager 3220 to determine the location of the device.

Finally, the discovery manager 3120 handles event-action association. Given an event (e.g., when a new AP comes up), the discovery manager 3120 initiates one or a series of actions (i.e., check whether the server should manage that device, and if so, locate it, etc.).

Security

The security manager 3130 in the server is responsible for managing security of one or more wireless networks operating in the frequency band under its domain. One type of security function is rogue AP detection. In rogue AP detection, a user can specify which APs are inside a security perimeter of the server and are authorized to operate in that security perimeter based on IP or MAC address. Sensors report the APs and STAs that they detect. The security manager 3130 processes these reports and determines whether an AP that is not authorized to operate inside the security perimeter has been detected. If so, then the security manager 3130 generates an alarm indicating the presence of a rogue AP. A sensor detects the presence of an AP. The security manager 3130 has the responsibility to declare the detected AP a rogue.

A client application (user) can specify the parameters of the security perimeter. The security manager 3130 configures the security perimeter accordingly, which may be a polygon or volume region specified by the user. Inside this perimeter are the devices that the user wants to protect. The security manager 3130 may generate an alert when a device physically located outside the security perimeter accesses a WLAN that is located inside the security perimeter. Conversely, the security manager 3130 may generate an alert when a device physically located inside the security perimeter accesses or sends data to a device outside the security perimeter or associates with an AP outside the security perimeter. Moreover, a client user can give a particular device operating within the domain of the server a “fixed location attribute.” The security manager 3130 detects whenever that “fixed location” device moves and reports it or generates an alert.

The low level services 3200 will now be described in more detail.

RF

The RF manager 3210 is responsible for aggregating and logging signal classification events from the classification engine 2720 in a sensor 2000, and for aggregating and logging spectrum statistics and raw spectrum information from the measurement engine 2710 of a sensor. The RF manager 3210 may also supply new or update existing classification templates or reference files to each sensor that the classification engine uses to classify RF signals.

Location

The location manager 3220 in the server handles the position computations to determine a position of a device operating in the frequency band using a receive signal strength position algorithm. An example of an receive signal strength position algorithm is described in commonly assigned and co-pending U.S. application Ser. No. 10/976,509, filed Oct. 29, 2004, entitled “System and Method for Locating Radio Emitters Using Self-Calibrated Path Loss Computation.” Other receive signal strength position algorithms are known in the art, such as described in P. Krishnan, A. S. Krishnakumar, W Ju, C. Mallows, S. Ganu, “A System for LEASE: Location Estimation Assisted by Stationary Emitters for Indoor RF Wireless Networks”, IEEE INFOCOM, 2004; P. Bahl et al, “RADAR: An In-Building RF-Based User Location and Tracking System”, IEEE Infocom, March 2000. Any receive signal strength algorithm may be used by the location manager 3220 to determine the position of radio emissions from devices using the techniques described herein.

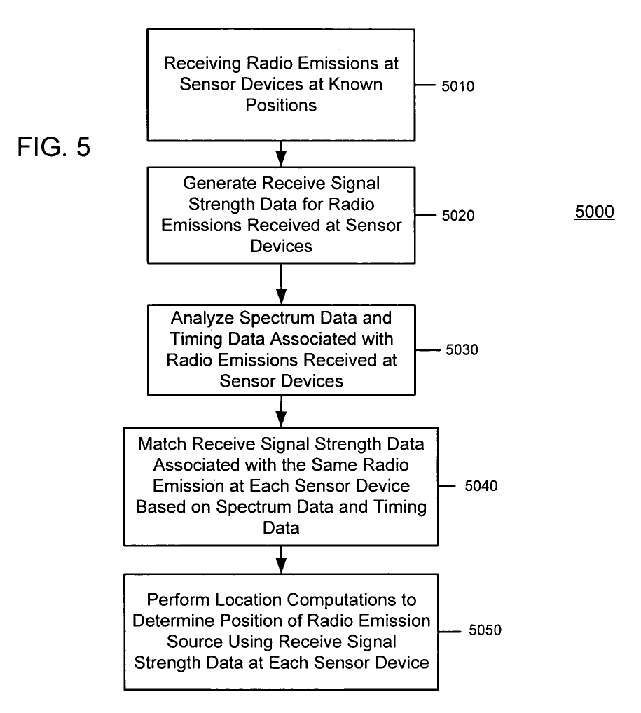

FIG. 5 shows a flow chart depicting a process 5000 by which spectrum analysis and timing data associated with reception of radio emissions are processed for purposes of estimating the position of these devices. In step 5010, the radio emissions from the TDs are received at the sensors which are located at known positions. In step 5020, each of the sensors generates receive signal strength data for the emissions received from the TDs. Next, in step 5030, the sensors perform spectrum analysis on the emission received from the TDs as well as timing analysis. It should be understood that the raw received or captured data from the sensors may be forwarded to the server where the spectrum analysis and timing analysis is performed instead of by the sensors.

The type of spectrum analysis performed in step 5030 may involve examining power versus frequency, power level, center frequency, bandwidth and power versus time characteristics all of which can be produced by the SAGE block in each sensor. The timing analysis may involve examining the time duration, time between pulses or bursts or energy, timing pattern of occurrence and duty cycle of received emissions at a sensor. Alternatively, more simply the sensors may generate a time that the sensor started detecting the emission and a time that the sensor stopped detecting the emission. In step 5040, based on the spectrum analysis and timing analysis of the received emissions at each of the sensors in step 5030, the receive signal strength data at the plurality of sensors from the various emissions are matched in order to perform position estimation computations on them. More specifically, in step 5040, analysis is performed on the spectrum data and timing data associated with reception of radio emissions at each of the plurality of sensors to match receive signal strength data generated at each of the plurality of sensors as corresponding to a radio emission from the same source. One way that the receive signal strength data may be matched is by comparing the time duration of the radio emissions reported by each sensors (time period from first to detected to no longer detected) and the corresponding spectrum analysis data (e.g., center frequency, bandwidth, power, duty cycle, etc.) and if all of this data matches (within some reasonable degree of tolerance), the corresponding receive signal strength data at each of the sensors is said to originate from the same radio emission source.

In step 5050, the location estimation computations are performed on the appropriately matched receive signal strength data from the sensors. Any receive signal strength position estimation techniques or algorithms may be used in step 5050. These algorithms are referred to above.

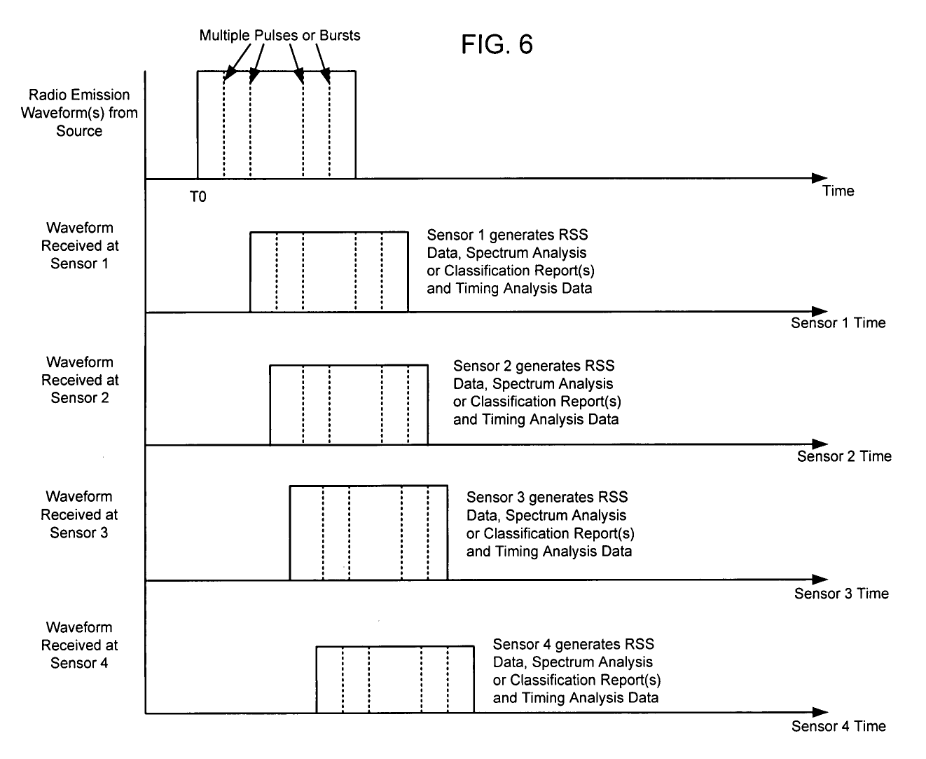

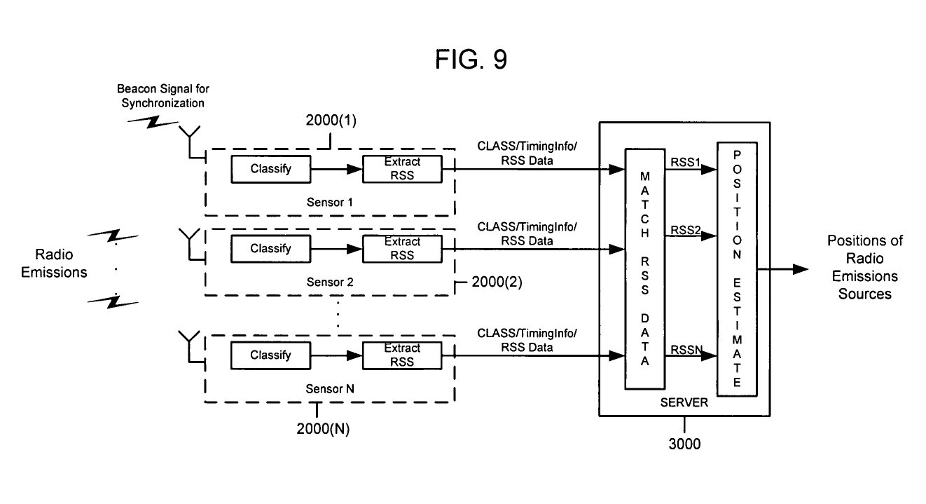

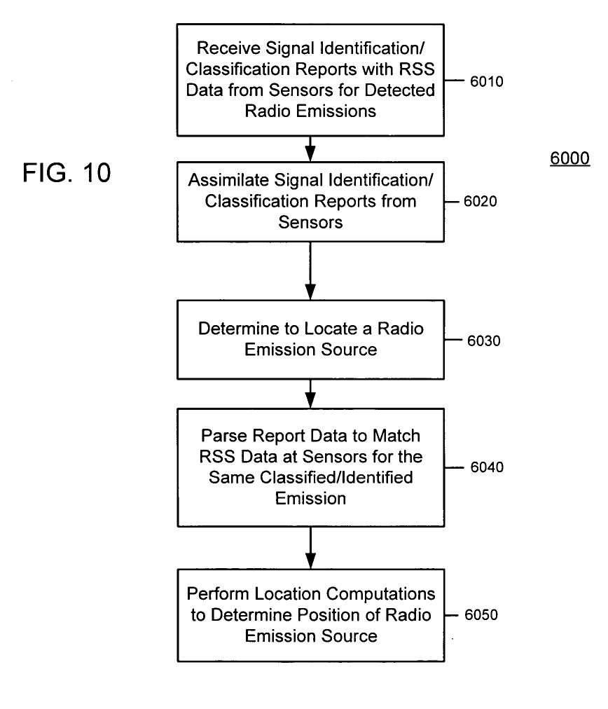

FIG. 6 illustrates an example where a radio emission from a source occurs at time T0 and ends some time interval later, and the emission is received at each of the four sensors. The radio emission may involve multiple pulses or bursts following a rigid timing pattern as shown in phantom in the figure. However, this is only an example, and the emission may be of any waveform or shape. Each sensor performs spectrum and timing analysis as described above in conjunction with FIG. 5 on the received emission (or a classification event/report is generated as described hereinafter in conjunction with FIGS. 9 and 10) and receive signal strength data is generated for the received emission at each sensor. This data is forwarded to the server where it compares the spectrum and timing analysis data to match receive signal strength data produced by the sensors as associated with the same emission source for purposes of position computations.

FIG. 6 also shows that in the event the clocks of the sensors are not synchronized, the time instant that a radio emission is receive may not be the same. FIG. 6 indicates that each sensor receives the radio emission at some time with respect to that sensor's clock.

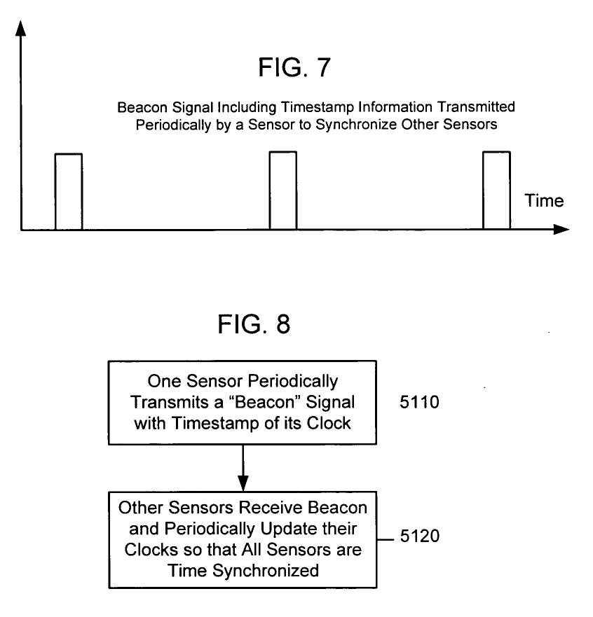

FIGS. 7 and 8 illustrate a technique for time synchronizing the sensors so that the reports of the RSS data and spectrum analysis/timing analysis data from all of the sensors are time synchronized. As suggested, the sensors may not be operating from a common clock and therefore analysis performed on the data they collect can be skewed and inaccurate without some synchronization technique. According to synchronization process 5100, in step 5110, one of the sensors periodically transmits a beacon signal that contains timestamp information of the clock in the sensor that transmits the beacon signal. In step 5102, each of the other sensors receives the beacon signal and recovers the timestamp information to update or synchronize its clock so that the spectrum analysis, timing analysis and receive signal strength data each sensor generates is synchronized to the same clock. In this way, when the sensors send the results of their timing analysis and spectrum analysis, these analysis reports will be time synchronized, making it easier for the server to match RSS data for the same emissions received at each of each of the sensors.

In the case of an arrangement of numerous sensors, the server may group sensors into a network that in turn is sub-divided into sub-networks. Each sub-network has one master sensor that transmits beacon signals for synchronization and all the other sensors in that sub-network re slave sensors that synchronize their clocks to the master. A sensor may be a master in one sub-network and a slave in another sub-network. For example, a sensor in sub-network 1 may be a master sensor (M1), and a sensor in that same sub-network is a slave sensor, but is also a master sensor (M2) in a different sub-network, sub-network 2. Sensor M2 will generate its and transmit beacon signals in sub-network 2 based on its own clock that is synchronized to the clock of master sensor M1 based on the beacon signals it received in sub-network 1 from master sensor M1.

There is another technique for synchronizing the sensors in the event it is desired that the sensors not transmit a signal, or they sensors do not have transmit capability. With reference back to FIG. 1, each of the sensors listen to a packet sent by any one of the APs or client stations in the 802.11 WLAN. Since each of the sensors has the ability to receive and demodulate 802.11 packets, the sensors can also recover the MAC address from the packet to identify the 802.11 WLAN device that sent the packet. In addition, each of the sensors can generate a timestamp to indicate the time (with respect to its own clock) that it received the packet from that same WLAN device. The sensors forward to the server timestamp and MAC address information for packets each sensor receives from 802.11 WLAN devices. The server then examines this information to determine the relative offset between the clocks of each sensor device based on the timestamp information associated with each sensor's reception of the same packet from a 802.11 WLAN device. This synchronization adjustment may be performed on a periodic basis. The server uses this clock offset information when examining spectrum analysis and classification reports from sensors in ascertaining when a radio emission received by each of the sensors is from the same source for purposes of selecting the proper set of receive signal strength data.

Referring to FIGS. 9 and 10, another process for determining the position of sources of radio emissions is described. In this process, more than only performing spectrum and timing analysis as shown in FIG. 5, each sensor classifies and/or identifies the emissions it detects using, for example, the signal classification techniques described in the aforementioned commonly assigned patent applications, or using the demodulation capability in the sensors as described hereinafter in conjunction with FIG. 11.

Broadly speaking, the type of signal classification referred to above may involve comparing frequency domain and time domain characteristics generated from reception of radio emissions at each of the plurality of radio receiver devices against signal classification templates of frequency domain and time domain characteristics associated with known signal types. Each sensor 2000(1) to 2000(N) forwards the signal classification information (signal type or if possible device model type or number) together with the associated RSS data, to the server 3000. Each sensor also performs timing analysis as described above in connection with FIG. 5 and supplies timing analysis data (time sensor detected radio emission and possibly the time sensor stopped detected the emission, in the event the emission stops) to the server with a classification event report. For example, a classification report from a sensor may classify a detected radio emission as one of: a Bluetooth™ SCO signal, a Bluetooth™ ACL signal, a microwave oven emission, a cordless telephone handset and/or base station, a wireless video camera device and a radar device. The server receives the signal classification (together with timing analysis data—time instances of occurrence and termination) and RSS data reports from the sensors and uses the signal classification/timing data to match receive signal strength data from the sensors to the same emission source in order to perform position estimation on the receive signal strength data from the same emission source.

A flow chart for the corresponding process is shown in FIG. 10. In step 6010, the signal classification reports, together with timing analysis data and receive signal strength data for classified radio emissions are forwarded by the sensors to the server. The server assimilates this data in step 6020. A request is made, or server application logic triggers, a decision to determine a location of a radio emission in step 6030. Next, in step 6040, the location manager service in the server parses the signal classification report data and timing analysis data from the sensors and matches receive signal strength data from the sensors with the same radio emission source. Then, in step 6050, the server performs location computations on the receive signal strength data generated at each of the plurality of radio receiver devices that corresponds to the same emission source. The synchronization technique depicted in FIGS. 6 and 7 may be employed in this process so that the classification/receive signal strength reports to the server are time synchronized, making it easier for the server to match receive signal strength data from the sensors to the same radio emission.

FIG. 11 illustrates another form of signal classification that may be used by the sensors. Rather than performing frequency and time based signal classification algorithms, each sensor 2000(1) to 2000(N) may have the capability of demodulating many of the different types of radio emissions. For example, each sensor has multiple demodulators (1-N) any one or more of which may be turned on when certain types of signals are recognized from their sync patterns. An example of the demodulators may include 802.11, Bluetooth™, cordless telephone demodulators, etc. These demodulators perform the baseband signal processing required to recover the transmitted data sufficiently to determine the radio emission type (e.g., protocol type) and possibly as far as to recover an identifier of the radio emission source, such as a MAC address. Consequently, each sensor can generate a precise signal classification report for the radio emissions it can demodulate. The report may contain an identification of the type of signal (e.g., Bluetooth™, Cordless phone, etc.), the associated receive signal strength data, time of occurrence information and MAC address or other device identifier information. Using the reports from the sensor, the server can easily match the receive signal strength data using the MAC or other identifier information and/or timing information.

To summarize, a method is provided for determining a position of a source of a radio emission, comprising generating receive signal strength data associated with reception of radio emissions at each of a plurality of sensor devices at corresponding known positions in an area; matching receive signal strength data generated at each of the plurality of sensor devices as corresponding to a radio emission from the same source based on characteristics associated with reception of the radio emission at each sensor device; and processing the receive signal strength data determined to be associated with reception of a radio emission from the same source at each of the sensor devices to determine a position of the source of the radio emission.

Similarly, a system is provided for determining a position of a source of a radio emission, comprising a plurality of sensor devices at corresponding known positions in an area, wherein each sensor device receives radio emissions in the area and generates receive signal strength data associated with reception of radio emissions; and a computing device coupled to each of the plurality of sensor devices, wherein the computing device matches receive signal strength data generated at each of the plurality of sensor devices as corresponding to a radio emission from the same source based on characteristics associated with reception of the radio emission at each radio sensor device, and processes the receive signal strength data associated with reception of a radio emission from said same source at each of the sensor devices to determine a position of the source of the radio emission.

Further still, method is provided for determining a position of a source of a radio emission, comprising generating receive signal strength data associated with reception of radio emissions at each of a plurality of sensor devices at corresponding known positions in an area; classifying radio emissions by type at each of the plurality of sensor devices; matching receive signal strength data generated at each of the plurality of sensor devices as corresponding to a radio emission from the same source based on the classification type determined by classifying the radio emissions; and processing receive signal strength data associated with reception of a radio emission from the same source at each of the radio receiver devices to determine a position of the source of the radio emission.

Still further, a processor readable medium storing instructions that, when executed by a processor, perform steps of matching receive signal strength data generated at each of the plurality of sensor devices as corresponding to a radio emission from the same source based on characteristics associated with reception of the radio emission at each sensor device; and processing the receive signal strength data determined to be associated with reception of a radio emission from the same source at each of the sensor devices to determine a position of the source of the radio emission.

The above description is intended by way of example only.

What is claimed is:

1. A method for determining a position of a source of a radio emission, comprising:
a. generating receive signal strength data associated with reception of radio emissions at each of a plurality of sensor devices at corresponding known positions in an area;
b. matching receive signal strength data generated at each of the plurality of sensor devices as corresponding to a radio emission from the same source based on characteristics associated with reception of the radio emission at each sensor device; and
c. processing the receive signal strength data determined to be associated with reception of a radio emission from the same source at each of the sensor devices to determine a position of the source of the radio emission.

2. The method of claim 1, and further comprising performing spectrum analysis on a radio emission received at each sensor device to produce spectrum analysis data, wherein matching comprises analyzing the spectrum analysis data associated with reception of radio emissions at each of the plurality of sensor devices.

3. The method of claim 2, wherein performing spectrum analysis comprises generating spectrum data including one or more of: power versus frequency data, power level, center frequency and bandwidth of the radio emission received at each of the sensor devices.

4. The method of claim 3, and further comprising performing timing analysis on radio emissions received at each sensor device to produce timing data, wherein matching comprises analyzing the spectrum data and timing data associated with reception of radio emissions at each of the plurality of sensor devices.

5. The method of claim 4, wherein performing timing analysis comprises producing time duration data for radio emissions received at each of the sensor devices.

6. The method of claim 1, wherein generating comprises generating receive signal strength data associated with reception of a plurality of radio emissions from corresponding ones of a plurality of sources.

7. The method of claim 6, wherein matching comprises matching receive signal strength data generated at each of the plurality of sensor devices as corresponding to a radio emission from a corresponding one of the plurality of sources.

8. The method of claim 7, wherein processing comprises processing the receive signal strength data associated with reception of each of the plurality of radio emissions at each of the plurality of sensor devices to determine a position of each of the plurality of sources.

9. The method of claim 1, and further comprising classifying radio emissions according to type at each of the plurality of sensor devices, and wherein matching comprises matching receive signal strength data generated at each of the plurality of sensor devices as corresponding to the same source based on the type of the radio emission source.

10. The method of claim 9, wherein classifying comprises comparing frequency domain and time domain characteristics generated from reception of radio emissions at each of the plurality of sensor devices with templates of frequency domain and time domain characteristics associated with known signal types.

11. The method of claim 10, wherein classifying comprises classifying a radio emission as one of: a Bluetooth™ SCO signal, a Bluetooth™ ACL signal, a microwave oven emission, a cordless telephone handset and/or base station, a wireless video camera device and a radar device.

12. The method of claim 1, and further comprising demodulating radio emissions received at each of the plurality of sensor devices thereby determining the type of radio emission received at each sensor device, wherein matching comprises matching the received signal strength data based on the type of radio emission determined by demodulating the radio emissions.

13. The method of claim 12, and further comprising recovering an identifier of the source of a radio emission from demodulation of the radio emission at each sensor device, and wherein matching comprises matching the received signal strength data from the plurality of sensor devices using the identifier.

14. The method of claim 1, and further comprising transmitting a signal from a first sensor device, the signal including timestamp information related to the clock of the first sensor device, wherein the other sensor devices receive the signal and synchronize their internal clocks based on the time stamp information included in the signal.

15. The method of claim 14, wherein transmitting comprises transmitting the signal from the first sensor device on a periodic basis.

16. A system for determining a position of a source of a radio emission, comprising:
a. a plurality of sensor devices at corresponding known positions in an area, wherein each sensor device receives radio emissions in the area and generates receive signal strength data associated with reception of radio emissions; and
b. a computing device coupled to each of the plurality of sensor devices, wherein the computing device matches receive signal strength data generated at each of the plurality of sensor devices as corresponding to a radio emission from the same source based on characteristics associated with reception of the radio emission at each sensor device, and processes the receive signal strength data associated with reception of a radio emission from said same source at each of the sensor devices to determine a position of the source of the radio emission.

17. The system of claim 16, wherein each sensor device performs spectrum analysis on a radio emission that it receives to produce spectrum analysis data that is supplied to the computing device, wherein the computing device matches the received signal strength data based on the spectrum data.

18. The system of claim 17, wherein each sensor device performs spectrum analysis to generate spectrum data including one or more of: power versus frequency data, power level, center frequency and bandwidth of the radio emission received at each of the sensor devices.

19. The system of claim 17, wherein each sensor device performs timing analysis on radio emissions it receives to produce timing data, and wherein the computing device matches receive signal strength data based on the spectrum data and timing data received from each of the sensor devices.

20. The system of claim 19, wherein each sensor device performs timing analysis to produce time duration data for radio emissions received at each of the sensor devices.

21. The system of claim 16, wherein each of the sensor devices generates receive signal strength data associated with reception of a plurality of radio emissions from corresponding ones of a plurality of sources.

22. The system of claim 21, wherein the computing device matches receive signal strength data generated at each of the plurality of sensor devices as corresponding to a radio emission from a corresponding one of the plurality of sources.

23. The system of claim 22, wherein the computing device processes the receive signal strength data associated with reception of each of the plurality of radio emissions at each of the plurality of sensor devices to determine a position of each of the plurality of sources.

24. The system of claim 16, wherein each sensor device classifies the radio emission it receives according to type, and wherein the computing device matches receive signal strength data generated at each of the plurality of sensor devices as corresponding to a radio emission from the same source based on the type determined by classifying the radio emissions.

25. The system of claim 24, wherein each sensor device classifies the radio emission by comparing frequency domain and time domain characteristics generated from reception of radio emissions at each of the plurality of sensor devices with templates of frequency domain and time domain characteristics associated with known signal types.

26. The system of claim 24, wherein each sensor device classifies the radio emission as one of: a Bluetooth™ SCO signal, a Bluetooth™ ACL signal, a microwave oven emission, a cordless telephone handset and/or base station, a wireless video camera device and a radar device.

27. The system of claim 26, wherein each radio sensor device demodulates radio emissions it receives thereby determining the type for the radio emission, wherein the computing device matches the received signal strength data based on the type of radio emission determined by demodulating the radio emissions.

28. The system of claim 27, wherein each sensor device recovers an identifier of the source of a radio emission from demodulation of the radio emission, and wherein the computing device matches the received signal strength data from the plurality of sensor devices using the identifier.

29. The system of claim 16, wherein a first sensor device transmits a signal including timestamp information related to the clock of the first sensor device, wherein the other sensor devices receive the signal and synchronize their internal clocks based on the timestamp information included in the signal.

30. A method for determining a position of a source of a radio emission, comprising:
a. generating receive signal strength data associated with reception of radio emissions at each of a plurality of sensor devices at corresponding known positions in an area;
b. classifying radio emissions by type at each of the plurality of sensor devices;
c. matching receive signal strength data generated at each of the plurality of sensor devices as corresponding to a radio emission from the same source based on the type determined by classifying the radio emissions; and
d. processing receive signal strength data associated with reception of a radio emission from the same source at each of the sensor devices to determine a position of the source of the radio emission.

31. The method of claim 30, wherein classifying comprises comparing frequency domain and time domain characteristics generated from reception of radio emissions at each of the plurality of sensor devices with templates of frequency domain and time domain characteristics associated with known signal types.

32. The method of claim 31, wherein classifying comprises classifying a radio emission as one of: a Bluetooth™ SCO signal, a Bluetooth™ ACL signal, a microwave oven emission, a cordless telephone handset and/or base station, a wireless video camera device and a radar device.

33. A processor readable medium storing instructions that, when executed by a processor, perform steps of:
a. matching receive signal strength data generated at each of the plurality of sensor devices as corresponding to a radio emission from the same source based on characteristics associated with reception of the radio emission at each sensor device; and
b. processing the receive signal strength data determined to be associated with reception of a radio emission from the same source at each of the sensor devices to determine a position of the source of the radio emission.
